(19) United States
(12) Patent Application Publication
(10) Pub. No.: US 2006/0262570 A1
(43) Pub. Date: Nov. 23, 2006

(54) Backlight assembly and display device having the same

(76) Inventor: Tae-Gil Kang, Suwon-si (KR)

Correspondence Address: CANTOR COLBURN, LLP, 55 GRIFFIN ROAD SOUTH, BLOOMFIELD, CT, 06002, US

(21) Appl. No.: 11/388,572

(22) Filed: Mar. 24, 2006

(30) Foreign Application Priority Data
May 18, 2005 (KR) 2005-41734

(51) Int. Cl. F21V 7/04

(52) U.S. Cl. 362/632

(57) ABSTRACT

A backlight assembly includes a receiving container and a light guiding plate. The light guiding plate includes a protrusion formed on a side portion facing a sidewall of the receiving container. When the light guiding plate drifts in the receiving container, the sidewall of the receiving container makes contact only with the protrusion extending from the light guiding plate, so that a contact area between the light guiding plate and the receiving container is reduced. Thus, a noise induced by friction between the light guiding plate and the receiving container may be prevented and a manufacturing yield thereof is enhanced.

This application claims priority to Korean Patent Application No. 2005-41734 filed on May 18, 2005, and all the benefits accruing therefrom under 35 U.S.C. §119, the contents of which in its entirety are herein incorporated by reference.

### BACKGROUND OF THE INVENTION

1. Field of the Invention

The present invention relates generally to a backlight assembly and a display device having the backlight assembly, and more particularly, relates to a backlight assembly capable of reducing noise and enhancing a manufacturing yield of a display device having the backlight assembly.

2. Description of the Related Art

Generally, a liquid crystal display (“LCD”) device includes an LCD panel and a backlight assembly. The LCD panel displays an image using light, and the backlight assembly provides the light to the LCD panel.

The backlight assembly includes a lamp unit that generates the light, a light guiding plate that guides the light to a display unit and a mold frame that receives the lamp unit and the light guiding plate.

The LCD device is usually oriented standing up (such that the surface defining the display screen defines a substantially vertical plane so that users look at a display screen of the LCD device in a substantially horizontal viewing angle. In an LCD device employed in portable devices such as a notebook computer, a cellular phone or a laptop computer, for example, an angle of the display screen relative to the horizontal plane is controllable so as to secure a proper viewing angle.

When an external force is applied to the LCD device so as to adjust the viewing angle of the display screen, the backlight assembly may be transformed due to the externally applied force, thereby causing the light guiding plate to drift. This is especially the case for a foldable device, where a main body and an LCD device are hinge-combined with each other, such that the light guiding plate may drift in the LCD device whenever the foldable device is folded or unfolded.

Thus, when the light guiding plate drifts in the receiving container, friction is generated between the light guiding plate and the receiving container, thereby inducing an undesirable noise.

Currently, the dimensions of the sidewalls defining the contact areas between light guiding plate and receiving container are closely matched during manufacturing to minimize drift of the light guiding plate relative to the receiving container. As a result, a manufacturing yield of the backlight assembly is reduced, because of the difficulty in precisely sizing the corresponding sidewalls of the light guiding plate and receiving container to define a close fit therebetween in such a large contact area.

### BRIEF SUMMARY OF THE INVENTION

The present invention obviates the above problems and thus the present invention provides a backlight assembly capable of reducing noise and enhancing a manufacturing yield.

The present invention also provides a display device having the above-mentioned backlight assembly.

In exemplary embodiments of the present invention, a backlight assembly includes a receiving container and a light guiding plate. The light guiding plate includes a base plate and a protrusion formed on a surface of the base plate. The protrusion makes point contact with the receiving container.

In other exemplary embodiments of the present invention, a backlight assembly includes a light guiding plate, a light source and a receiving container. The light source is disposed at a side of the light guiding plate to generate the light. The light guiding plate receives the light from the light source, changes an optical path of the light and emits the light. The receiving container includes a bottom plate on which the light guiding plate and the light source are disposed, a sidewall extending from the bottom plate to face a side portion of the light guiding plate and a protrusion protruding from the sidewall to space the sidewall apart from the side portion of the light guiding plate.

In still other exemplary embodiments of the present invention, a display device includes a receiving container, a light guiding plate, a light source and a display panel. The light source is disposed at a side of the light guiding plate to provide light to the light guiding plate. The light guiding plate includes a base plate received in the receiving container to change an optical path of light from the light source disposed at a side of the light guiding plate and a protrusion disposed on a surface of the base plate. The protrusion makes point contact with the receiving container. The display panel is disposed over the light guiding plate to display an image using the light from the light guiding plate.

According to the above exemplary embodiments, when the light guiding plate drifts in the receiving container, a sidewall of the receiving container makes contact only with the protrusion formed on the light guiding plate, so that a contact area between the light guiding plate and the receiving container is reduced. Thus, noise induced by friction between the light guiding plate and the receiving container may be prevented, and enhance a manufacturing yield of both the light guiding plate and receiving container.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view illustrating an exemplary embodiment of a backlight assembly according to the present invention;

FIG. 2 is a perspective view illustrating the light guiding plate shown in FIG. 1;

FIG. 3 is a plan view illustrating the light guiding plate shown in FIG. 2;

FIG. 4 is an enlarged perspective view illustrating a first protrusion in portion ‘A’ in FIG. 2;

FIG. 5 is a partial plan view illustrating a relationship between a position of the light guiding plate and a receiving container shown in FIG. 1;

FIG. 6 is a cross-sectional partial view taken along a line I-I′ in FIG. 1;

FIG. 7 is a partial perspective view illustrating another example embodiment of the first protrusion in FIG. 4;

FIG. 8 is an enlarged perspective view illustrating a first fixing member in portion ‘B’ in FIG. 2;

FIG. 9 is a cross-sectional partial view taken along a line II-II′ in FIG. 1;

FIG. 10 is an exploded perspective view illustrating another exemplary embodiment of a backlight assembly according to the present invention;

FIG. 11 is a plan view illustrating the receiving container shown in FIG. 10;

FIG. 12 is an enlarged perspective view illustrating a protrusion in portion ‘C’ in FIG. 11;

FIG. 13 is a partial plan view illustrating a relationship between a position of a light guiding plate and a receiving container shown in FIG. 10;

FIG. 14 is a cross-sectional partial view taken along a line III-III′ in FIG. 10; and

FIG. 15 is an exploded perspective view illustrating an exemplary embodiment of a liquid crystal display device according to the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout. It will be understood that when an element such as a layer, region or substrate is referred to as being “on” or “onto” another element, it may be directly on the other element or intervening elements may also be present. In contrast, when an element is referred to as being “directly on” another element, there are no intervening elements present.

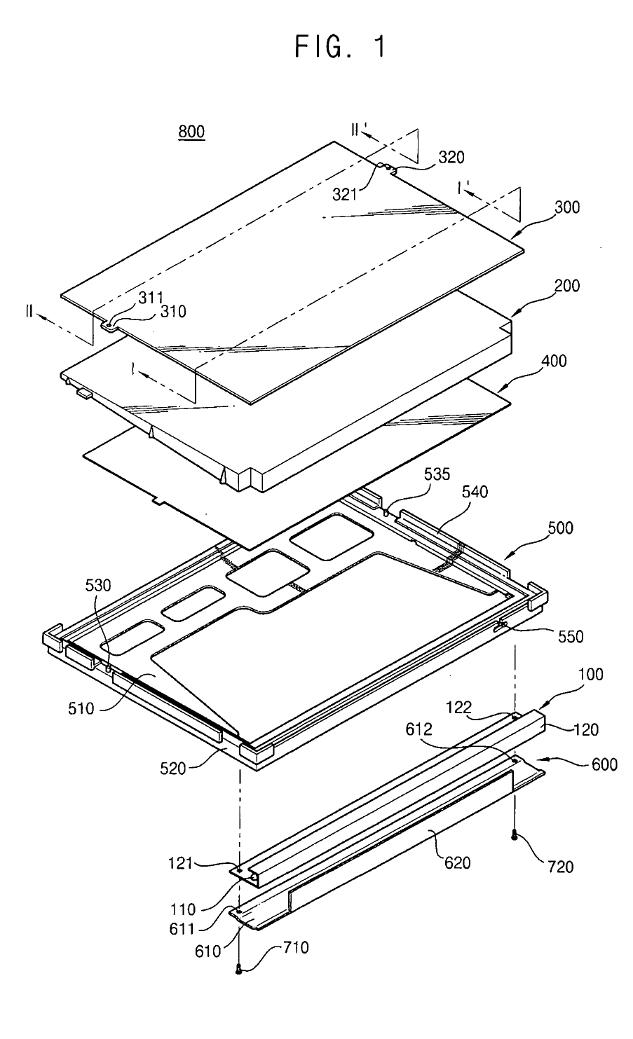

FIG. 1 is an exploded perspective view illustrating an exemplary embodiment of a backlight assembly according to the present invention.

Referring to FIG. 1, a backlight assembly 800 includes a lamp unit 100, a light guiding plate 200, an optical sheet 300, a reflective sheet 400 and a receiving container 500. The lamp unit 100 generates light. The light guiding plate 200 is disposed at a side of the lamp unit 100 to guide the light generated from the lamp unit 100. The optical sheet 300 is disposed over one surface of the light guiding plate 200. The reflective sheet 400 is disposed under an opposite surface of the light guiding plate 200.

The lamp unit 100 includes a lamp 110 operably connected to a power source to generate the light and a lamp cover 120 to receive the lamp 110 and reflect the light from the lamp 110.

A reflection member is coated on a surface of the lamp cover 120, which corresponds to the lamp 110, to reflect the light. The reflection member coated on the surface of the lamp cover 120 reflects the light from the lamp 110 toward the light guiding plate 200, thereby enhancing an optical efficiency of the backlight assembly 800.

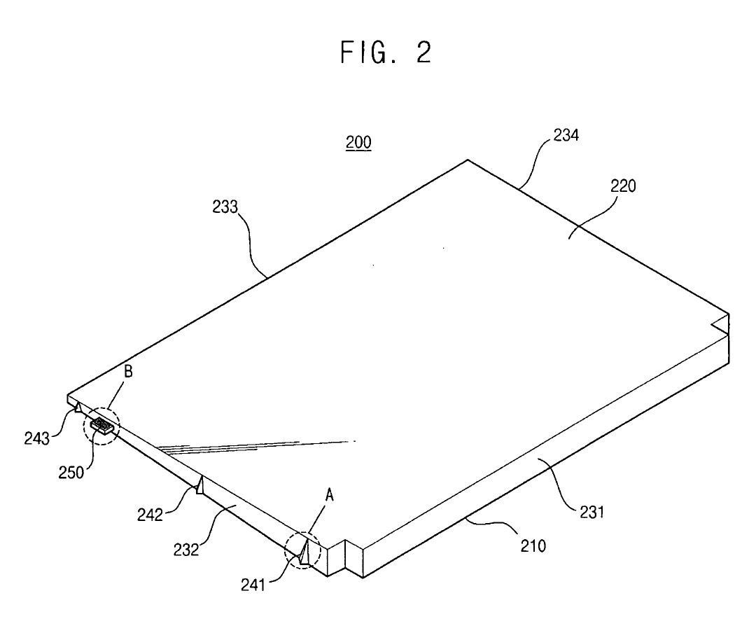

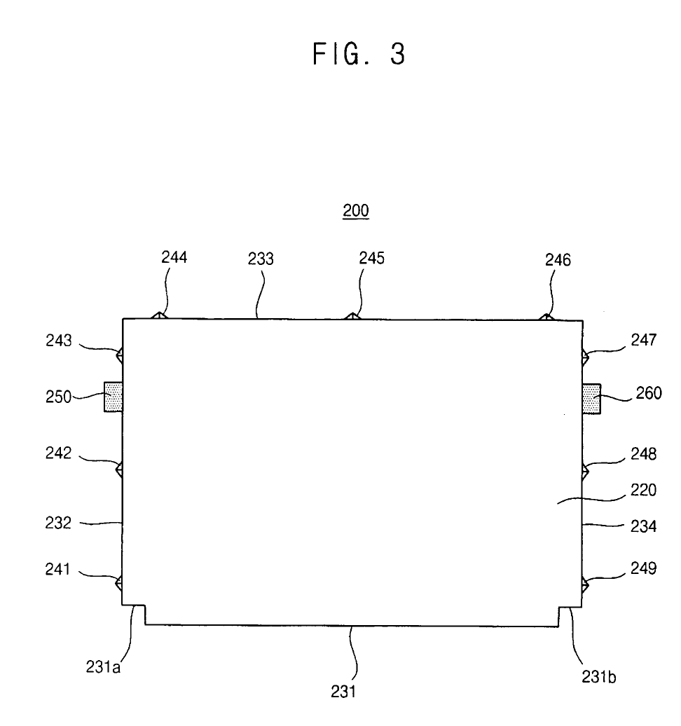

The light guiding plate 200 changes an optical path of linear light from the lamp unit 100 to provide planar light. In one exemplary embodiment, the light guiding plate 200 has a wedge shape. Thus, a thickness of the light guiding plate 200 may become gradually thinner from one end portion adjacent to the lamp unit 100 to the other end portion corresponding to an end portion opposite the one end portion. Alternatively, the thickness of the light guiding plate 200 may be substantially uniform from the one end portion to the other opposite end portion. The light guiding plate 200 will be later described in detail below, in the description of FIGS. 2 and 3.

The optical sheet 300 disposed over the light guiding plate 200 enhances optical characteristics, such as luminance and luminance uniformity of the light provided from the light guiding plate 200. The optical sheet 300 includes, for example, a prism sheet and/or a light-diffusing sheet. The backlight assembly 800 may include at least one optical sheet. A light-diffusing sheet and/or a prism sheet may be additionally employed in the backlight assembly 800 or omitted from the backlight assembly 800, which may be determined based on the desired optical characteristics.

The optical sheet 300 optionally includes a first fixing part 310 and a second fixing part 320. The first and second fixing parts 310 and 320, respectively, are formed at first and second sides, respectively, of the optical sheet 300 to combine the optical sheet 300 with the receiving container 500. The first and second fixing parts 310 and 320 protrude from the first and second sides of the optical sheet 300, respectively. First and second holes 311 and 321, respectively, are formed through the first and second fixing parts 310 and 320, respectively, to combine the optical sheet 300 with the receiving container 500.

The reflective sheet 400 disposed under the light guiding plate 200 reflects light, which exits the light guiding plate 200 through a lower surface of the light guiding plate 200, toward the upper surface, thereby enhancing an optical efficiency.

The receiving container 500 receives the lamp unit 100, the light guiding plate 200, the optical sheet 300 and the reflective sheet 400. The receiving container 500 includes a bottom plate 510 and a sidewall 520 extending from the bottom plate 510 to define a receiving space.

The bottom plate 510 has a plurality of openings to reduce a weight of the backlight assembly 800. The reflective sheet 400, the light guiding plate 200 and the optical sheet 300 are successively received on the bottom plate 510. The lamp unit 100 is inserted into the receiving container 500 from a rear surface of the receiving container 500, and positioned between the light guiding plate 200 and the sidewall 520 of the receiving container 500.

The receiving container 500 may include first and second bosses 530 and 535, respectively, corresponding to the first and second holes 311 and 321, respectively, of the optical sheet 300. The first and second bosses 530 and 535 are inserted through the first and second holes 311 and 321, respectively, to fix the optical sheet 300 to the receiving container 500.

The receiving container 500 may further include a guide part 540 and a wire-fixing hole 550. The guide part 540 guides a liquid crystal display panel (not shown) that displays an image. The wire-fixing hole 550 fixes a lamp wire (not shown) for providing electrical power from the power source to the lamp 110. The guide part 540 is disposed on an upper portion of the sidewall 520 and protrudes outwardly in comparison with the sidewall 520. The wire-fixing hole 550 is formed at the sidewall 520 and is positioned adjacent to the lamp unit 100. The lamp wire (not shown) is inserted into the wire-fixing hole 550, and an end portion of the lamp wire is drawn out from the wire-fixing hole 550. The end portion of the lamp wire is electrically connected to a power supply part (not shown) that provides electrical power from the power source.

The backlight assembly 800 may further include a back cover 600 disposed outside the receiving container 500. The back cover 600 is disposed adjacent to the lamp unit 100 to rapidly dissipate heat generated from the lamp unit 100. The back cover 600 covers a lower surface of the lamp cover 120 and a side of the receiving container 500.

In one exemplary embodiment, the backlight assembly 800 includes both the back cover 600 and the lamp cover 120. Alternatively, instead of separately including the back cover 600, the backlight assembly 800 may include a lamp cover having a function of the back cover 600.

The back cover 600 includes a first plate 610 making contact with the lamp cover 120 and a second plate 620 extending from the first plate 610 to make contact with the sidewall 520 of the receiving container 500. The lamp cover 120 has first combination holes 121 and 122 so that the lamp cover 120 may be combined with the back cover 600 through the first combination holes 121 and 122. The first plate 610 of the back cover 600 has second combination holes 611 and 612 corresponding to the first combination holes 121 and 122, respectively.

Although not shown in FIG. 1, combination grooves are formed on a rear surface of the receiving container 500. The combination grooves correspond to the first combination holes 121 and 122 and the second combination holes 611 and 612.

The back cover 600 is combined with the lamp cover 120 and the receiving container 500 by engaging screws 710 and 720 through the first combination holes 121 and 122 and the second combination holes 611 and 612, respectively.

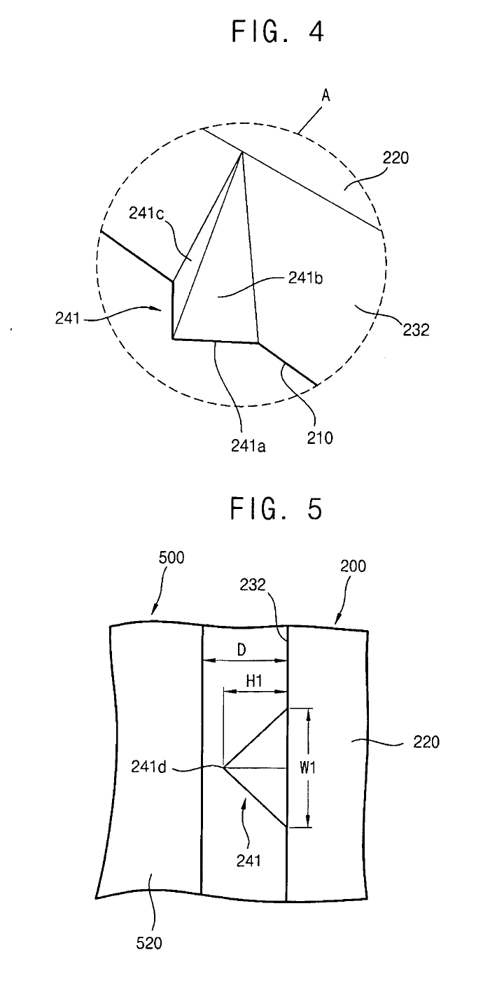

FIG. 2 is a perspective view illustrating the light guiding plate shown in FIG. 1. FIG. 3 is a plan view illustrating the light guiding plate shown in FIG. 2. FIG. 4 is an enlarged perspective view illustrating a portion ‘A’ in FIG. 2.

Referring to FIGS. 2 and 3, the light guiding plate 200 includes a light-guiding face 210 changing an optical path of light, a light-exiting face 220 facing the light-guiding face 210, a side portion adjacent to the light-guiding face 210 and the light-exiting face 220, and a plurality of protrusions formed on the side portion.

The light-guiding face 210 has a guide pattern (not shown) that changes an optical path of light and provides the light to the light-exiting face 220. The light-exiting face 220 provides the light from the opposite light-guiding face 210 to the optical sheet 300 shown in FIG. 1.

The side portion of the light guiding plate 200 includes a light-incident face 231 onto which the light from the lamp 110 is incident, and first, second and third side faces 232, 233 and 234, respectively. The light-incident face 231 faces the lamp 110, and light from the lamp 110 is incident onto the light-incident face 231. The first side face 232 is adjacent to the light-incident face 231. The second side face 233 is adjacent to the first side face 232, and faces the light-incident face 231. The third side face 234 is adjacent to the second side face 233 and the light-incident face 231, and faces the first side face 232.

The light-incident face 231 and the first side face 232 meet each other at a first corner 231a, and the light-incident face 231 and the third side face 234 meet each other at a second corner 231b. The first and second corners 231a and 231b are chamfered to prevent drifting of the light guiding plate 200 toward the lamp unit 100 shown in FIG. 1.

Although not shown in FIGS. 1 through 3, the receiving container 500 in FIG. 1 has a protruding portion corresponding to the chamfered portion of the light guiding plate 200, and the protruding portion is inserted into the chamfered portion of the light guiding plate 200 to prevent the light guiding plate 200 from drifting toward the lamp 110.

A plurality of protrusions is formed on the first, second and third side faces 232, 233 and 234. The protrusions are formed on portions of the light guiding plate 200, which may make contact with the sidewall 520 of the receiving container 500 shown in FIG. 1.

In one exemplary embodiment, the protrusions include first, second, third, fourth, fifth, sixth, seventh, eighth and ninth protrusions 241, 242, 243, 244, 245, 246, 247, 248 and 249, respectively. Alternatively, the number of the protrusions may be increased or decreased in accordance with a size of the light guiding plate 200.

In one exemplary embodiment, the first, second, third, fourth, fifth, sixth, seventh, eighth and ninth protrusions 241, 242, 243, 244, 245, 246, 247, 248 and 249 are integrally formed with the first, second and third side faces 232, 233 and 234. Alternatively, the first, second, third, fourth, fifth, sixth, seventh, eighth and ninth protrusions 241, 242, 243, 244, 245, 246, 247, 248 and 249 may not be integrally formed with the first, second and third side faces 232, 233 and 234 and may be formed separately from the side faces. The first, second, third, fourth, fifth, sixth, seventh, eighth and ninth protrusions 241, 242, 243, 244, 245, 246, 247, 248 and 249 may include an elastic material such as rubber.

The first, second and third protrusions 241, 242 and 243 protrude from the first side face 232, and are spaced apart from each other. The fourth, fifth and sixth protrusions 244, 245 and 246 protrude from the second side face 233, and are spaced apart from each other. The seventh, eighth and ninth protrusions 247, 248 and 249 protrude from the third side face 234, and are spaced apart from each other.

When the light guiding plate 200 received in the receiving container 500 drifts due to an external impact, the first, second, third, fourth, fifth, sixth, seventh, eighth and ninth protrusions 241, 242, 243, 244, 245, 246, 247, 248 and 249 provide a decreased contact area between sidewall 520 of the receiving container 500 and the light guiding plate 200. Thus, a noise induced by friction between the light guiding plate 200 and the receiving container 500 may be prevented.

In one exemplary embodiment, the first, second, third, fourth, fifth, sixth, seventh, eighth and ninth protrusions 241, 242, 243, 244, 245, 246, 247, 248 and 249 have substantially the same structure as one another. Thus, hereinafter, the first protrusion 241 will be described in detail, and any further descriptions of the second, third, fourth, fifth, sixth, seventh, eighth and ninth protrusions 242, 243, 244, 245, 246, 247, 248 and 249 will be omitted.

Referring to FIG. 4, the first protrusion 241 is positioned on the first side face 232, and has a triangular pyramid shape. Alternatively, the first protrusion 241 may have various polygonal pyramid shapes, for example, such as a quadrangular pyramid shape, a pentagonal pyramid shape, etc.

The first protrusion 241 includes a first face 241a, a second face 241b and a third face 241c. The first face 241a extends from the light-guiding face 210 and is substantially parallel with the light-guiding face 210. As illustrated, the first face 241a is coplanar with the light-guiding face 210, but is not required. The second face 241b forms a predetermined angle with respect to the first side face 232. The third face 241c forms a predetermined angle with respect to the first side face 232 and meets the second face 241b.

The second and third faces 241b and 241c are inclined in opposite directions to each other. The first, second and third faces 241a, 241b and 241c are adjacent to one another.

Hereinafter, a relationship between the position of the protrusions and the receiving container will be described in detail with reference to the accompanying drawings.

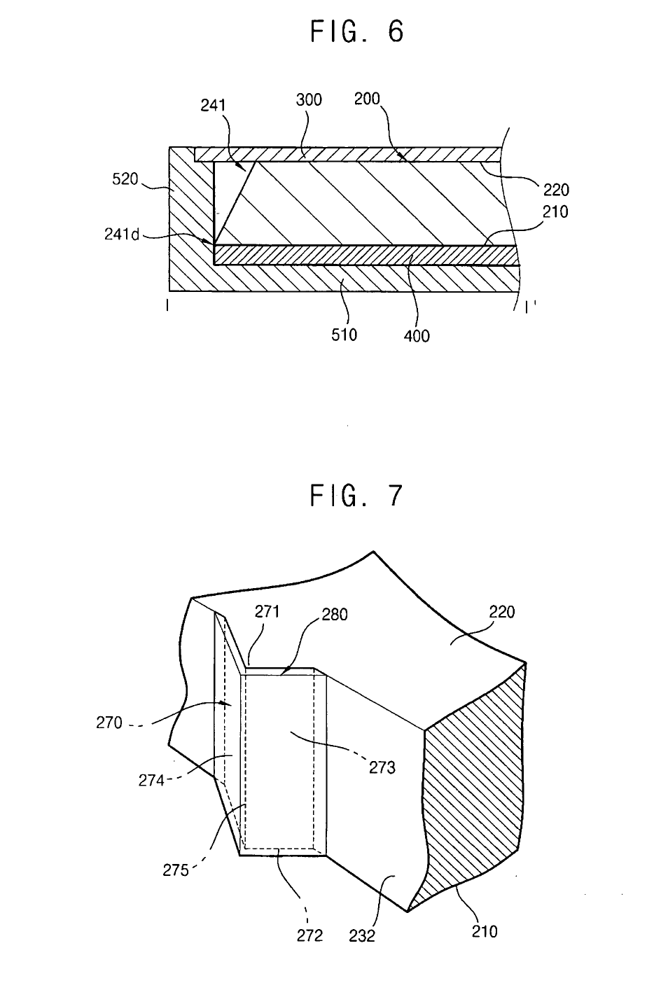

FIG. 5 is a partial plan view illustrating a position relationship between the light guiding plate 200 and the receiving container 500 shown in FIG. 1. FIG. 6 is a cross-sectional view taken along a line I-I′ in FIG. 1.

In one exemplary embodiment, the first, second, third, fourth, fifth, sixth, seventh, eighth and ninth protrusions 241, 242, 243, 244, 245, 246, 247, 248 and 249, respectively, have substantially the same positional relationship with respect to the sidewall 520 of the receiving container 500. Thus, only a positional relationship between the first protrusion 241 and the receiving container 500 will be described in detail with reference to FIGS. 5 and 6.

Referring to FIGS. 5 and 6, the reflective sheet 400, the light guiding plate 200 and the optical sheet 300 are successively received in the receiving container 500.

The first protrusion 241 formed on the first side face 232 of the light guiding plate 200 is positioned between the first side face 232 and the sidewall 520 of the receiving container 500. A first height ‘H1’ of the first protrusion 241 is smaller than or equal to a distance ‘D’ between the sidewall 520 of the receiving container 500 and the first side face 232. For example, the first protrusion 241 has a first width ‘W1’ of about 0.8 mm and the first height ‘H1’ of about 0.4 mm.

A pyramid apex 241d defined by an intersection of the first, second and third faces 241a, 241b and 241c of the first protrusion 241 shown in FIG. 4 is adjacent to the sidewall 520 of the receiving container 500.

When the light guiding plate 200 drifts in the receiving container 500, the first protrusion 241 of the light guiding plate 200 makes contact with the sidewall 520 of the receiving container 500. However, the first side face 232 of the light guiding plate 200 does not make contact with the sidewall 520 of the receiving container 500. Only the first protrusion 241 makes contact with the sidewall 520 of the receiving container 500 at the pyramid apex 241d. In other words, the light guiding plate 200 makes point contact with the sidewall 520 of the receiving container 500, as opposed to large surface contact of first side face 232 with the sidewall 520.

Although not shown in FIGS. 5 and 6, when the light guiding plate 200 drifts in the receiving container 500, the second, third, fourth, fifth, sixth, seventh, eighth and ninth protrusions 242, 243, 244, 245, 246, 247, 248 and 249 shown in FIG. 3 make point contact with the sidewall 520 at each pyramid apex only, which is similar to the first protrusion 241 (e.g., at 241d).

As described above, when the light guiding plate 200 drifts in the receiving container 500, the first, second, third, fourth, fifth, sixth, seventh, eighth and ninth protrusions 241, 242, 243, 244, 245, 246, 247, 248 and 249 shown in FIG. 3 make contact with the sidewall 520 of the receiving container 500 at each pyramid apex only.

An externally provided force causes the backlight assembly 800 to generate friction between the light guiding plate 200 and the receiving container 500, and thereby induces a noise. The pyramid apexes of the first, second, third, fourth, fifth, sixth, seventh, eighth and ninth protrusions 241, 242, 243, 244, 245, 246, 247, 248 and 249 of the light guiding plate 200 make contact with the sidewall 520 of the receiving container 500, thus minimizing a contact area between the light guiding plate 200 and the receiving container 500.

Thus, the noise induced by the friction between the light guiding plate 200 and the sidewall 520 of the receiving container 500 may then be prevented.

The friction generated noise may be generated due to a material of the light guiding plate 200. In general, a noise induced by friction between two objects is generated by one object having a greater coefficient of friction than the other object. In exemplary embodiments, the light guiding plate 200 includes a material having a greater coefficient of friction than the receiving container 500.

The light guiding plate 200 is formed, for example, of an acrylic resin including, for example, polymethyl methacrylate (PMMA). A coefficient of friction of PMMA is about 0.83. The receiving container 500, for example, may be formed of a polycarbonate (PC) having a coefficient of friction that is smaller than that of PMMA. The coefficient of friction of PC is about 0.36.

When the friction between the light guiding plate 200 and the receiving container 500 occurs, the noise is generated by the light guiding plate 200 because the light guiding plate 200 has a greater coefficient of friction than the receiving container 500. Thus, a small contact area of the light guiding plate 200 with respect to the receiving container 500 may effectively prevent the noise generated by friction therebetween.

FIG. 7 is a partial perspective view illustrating another exemplary embodiment of the first protrusion in FIG. 4.

Referring to FIG. 7, the first protrusion 270 is protruded from the first side face 232, and has, for example, a prism shape.

In one exemplary embodiment, the first protrusion 270 is integrally formed with the first side face 232. Alternatively, the first protrusion 270 may not be integrally formed with the first side face 232 and is separately formed. The first protrusion 270 may include an elastic material such as rubber.

The first protrusion 270 includes a first face 271, a second face 272, a third face 273 and a fourth face 274. The first face 271 extends from the light-exiting face 220. The second face 272 faces the first face 271. The third face 273 forms a predetermined angle with respect to the first side face 232. The fourth face 274 forms a predetermined angle with respect to the first side face 232, and meets the third face 273.

The first face 271 is substantially in parallel with the light-exiting face 220, and the second face 272 extending from the light-guiding face 210 is substantially parallel with the first face 271. The third and fourth faces 273 and 274 are inclined in an opposite direction to each other with respect to the first side face 232, and meet the first and second faces 271 and 272.

Although not shown in FIG. 7, when the light guiding plate 200 drifts in the receiving container 500 shown in FIG. 1, an edge 275, defined by intersection of the third and fourth faces 273 and 274, of the first protrusion 270 makes contact with the sidewall 520 of the receiving container 500 shown in FIG. 1.

The first protrusion 270 of the light guiding plate 200 makes contact with the sidewall 520 of the receiving container 500 at the edge 275 only. The first side face 232 of the light guiding plate 200 does not make contact with the sidewall 520 of the receiving container 500. Thus, a contact area between the light guiding plate 200 and the sidewall 520 of the receiving container 500 is reduced, so that a noise induced by friction between the light guiding plate and the receiving container may be prevented.

The light guiding plate 200 may further include a noise-proof member 280 to cover the third and fourth faces 273 and 274 of the first protrusion 270. Although the noise-proof member 280 is disposed on the first protrusion 270 in FIG. 7, the noise-proof member 280 may be disposed on not only the first protrusion 270 but also on the second through ninth protrusions.

The noise-proof member 280 may include a material having a coefficient of friction smaller than the first protrusion 270 and the receiving container 500 to reduce a noise induced by friction between the sidewall 520 of the receiving container 500 and the first protrusion 270.

For example, when the first protrusion 270 includes PMMA and the receiving container 500 includes PC, the noise-proof member 280 may include polyethylene terephthalate (PET) that has a smaller coefficient of friction than PMMA and PC. The coefficient of friction of PET ranges from about 0.08 to about 0.18.

Although not shown in FIGS. 1 through 6, the noise-proof member 280 may be disposed on the protrusions 241, 242, 243, 244, 245, 246, 247, 248 and 249 shown in FIGS. 1 through 6.

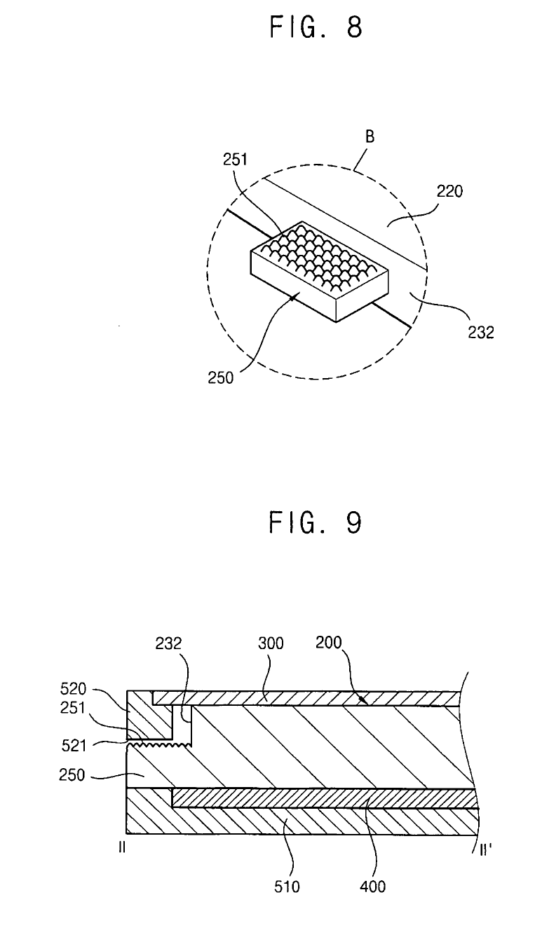

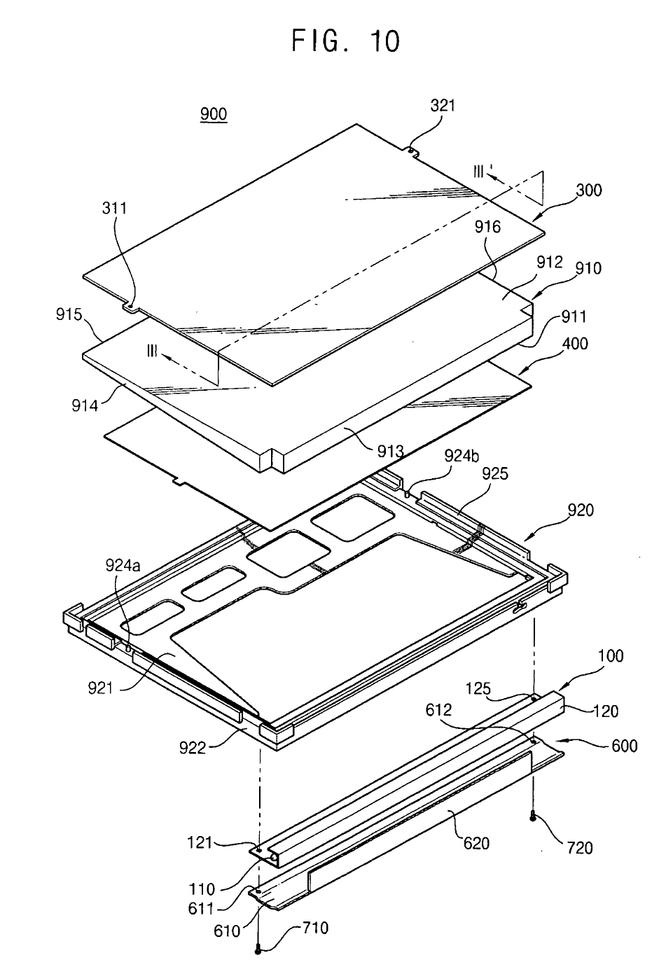

FIG. 8 is an enlarged perspective view illustrating a portion ‘B’ in FIG. 2. FIG. 9 is a cross-sectional view taken along a line II-II′ in FIG. 1.

Referring to FIGS. 3 and 8, the light guiding plate 200 may further include first and second fixing members 250 and 260, respectively, to be combined with the receiving container 500, thereby fixing the light guiding plate 200 to the receiving container 500.

The first fixing member 250 protrudes from the first side face 232, and the second fixing member 260 protrudes from the third side face 233 facing the first side face 232.

In one exemplary embodiment, the first and second fixing members 250 and 260 have substantially the same structure. Thus, hereinafter, the first fixing member 250 will be described in detail, and any further description of the second fixing member 260 will be omitted.

Referring to FIGS. 8 and 9, the first fixing member 250 has, for example, a quadrangular cylindrical shape, and is thinner than the first side face 232.

The sidewall 520 of the receiving container 500 has a first insertion hole 521 into which the first fixing member 250 is inserted. Although not shown in FIGS. 8 and 9, the sidewall 520 of the receiving container 500 has a second insertion hole into which the second fixing member 260 is inserted, as will be recognized by those skilled in the art.

The first insertion hole 521 is formed to correspond with the first fixing member 250, and the first fixing member 250 is inserted into the first insertion hole 521 to fix the light guiding plate 200 to the receiving container 500.

When the light guiding plate 200 drifts in the receiving container 500, friction is generated between the first fixing member 250 and an inner surface defining the first insertion hole 521 of the sidewall 520. Particularly, the friction between an upper face 251 of the first fixing member 250, which is positioned near to the light-exiting face 220, and the sidewall 520 may generate a noise. Therefore, the upper face 251 of the first fixing member 250 is corrosion-treated so as to prevent the noise.

In other words, the upper face 251 of the first fixing member 250 has a plurality of concave and convex portions so as to be non-flat, thereby reducing a contact area between the first fixing member 250 and the upper face 251 of the sidewall 520. Thus, the noise induced by the friction between the first fixing member 250 and the sidewall 520 of the receiving container 500 may be prevented.

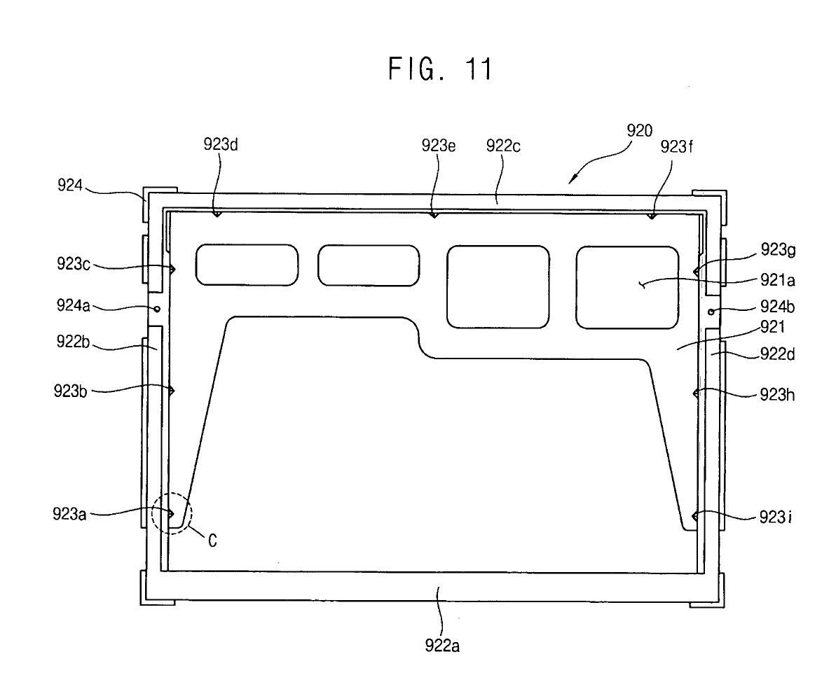

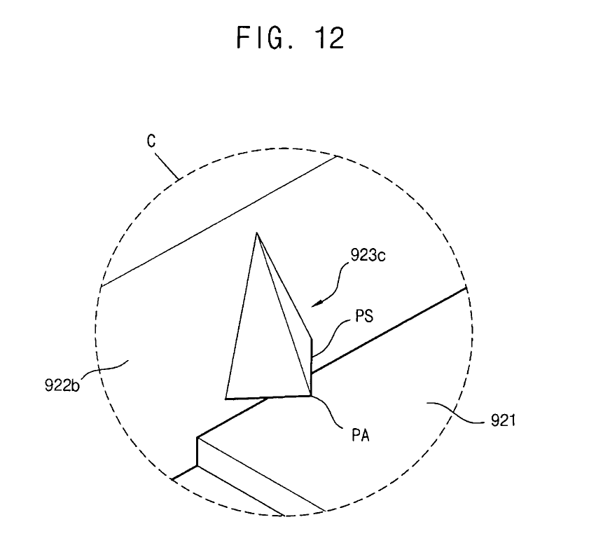

FIG. 10 is an exploded perspective view illustrating a backlight assembly according to another exemplary embodiment of the present invention. FIG. 11 is a plan view illustrating the receiving container shown in FIG. 10. FIG. 12 is an enlarged perspective view illustrating a portion ‘C’ in FIG. 11.

In FIG. 10, similar or identical elements to those of the backlight assembly 800 shown in FIG. 1 will be referred to with the same reference numerals, and any further descriptions thereof will be omitted.

Referring to FIG. 10, a backlight assembly 900 includes a lamp unit 100, a light guiding plate 910, an optical sheet 300, a reflective sheet 400 and a receiving container 920. The lamp unit 100 generates light. The light guiding plate 910 is disposed at a side of the lamp unit 100 to guide the generated light from the lamp unit 100. The optical sheet 300 is disposed over the light guiding plate 910. The reflective sheet 400 is disposed under the light guiding plate 910.

The lamp unit 100 includes a lamp 110 receiving power from a power source to generate the light. The lamp unit 100 also includes a lamp cover 120 receiving the lamp 110.

The light guiding plate 910 changes an optical path of the light from the lamp unit 100 to provide planar light. In one exemplary embodiment, the light guiding plate 910 has a wedge shape. Thus, a thickness of the light guiding plate 910 may become gradually thinner from one end portion adjacent to the lamp unit 100 to the other end portion corresponding to an opposite end of the one end portion. Alternatively, the thickness of the light guiding plate may be substantially uniform from the one end portion to the other end portion.

The light guiding plate 910 includes a light-guiding face 911 changing an optical path of light, a light-exiting face 912 facing the light-guiding face 911 and a side portion adjacent to and substantially normal to the light-guiding face 911 and the light-exiting face 912.

The light-guiding face 911 has a guide pattern (not shown) that changes the optical path of the light and provides the light to the light-exiting face 912. The light-exiting face 912 provides the light from the light-guiding face 911 to the optical sheet 300.

The side portion of the light guiding plate 910 includes a light-incident face 913 onto which the light is incident, and first, second and third side faces 914, 915 and 916. The light-incident face 913 faces the lamp 110. The first side face 914 is adjacent to the light-incident face 913. The second side face 915 is adjacent to the first side face 914, and faces the light-incident face 913. The third side face 916 is adjacent to the light-incident face 913, and faces the first side face 914.

The receiving container 920 successively receives the reflective sheet 400, the light guiding plate 910 and the optical sheet 300.

Referring to FIGS. 11 and 12, the receiving container 920 includes a bottom plate 921, a sidewall part 922 extending from the bottom plate 921 to define a receiving space, and a plurality of protrusions protruding from the sidewall part 922.

The bottom plate 921 has a plurality of openings 921a to reduce a weight of the backlight assembly 900. The reflective sheet 400, the light guiding plate 910 and the optical sheet 300 are successively received on the bottom plate 921. The lamp unit 100 is inwardly inserted into the receiving container 920 from a rear surface of the receiving container 920.

The sidewall part 922 includes first, second, third and fourth sidewalls 922a, 922b, 922c and 922d, respectively. The first sidewall 922a is adjacent to the lamp unit 100, and the lamp unit 100 is received between the light guiding plate 910 and the first sidewall 922a. The second sidewall 922b is adjacent to the first sidewall 922a. The third sidewall 922c is adjacent to the second sidewall 922b, and faces the first sidewall 922a. The fourth sidewall 922d is adjacent to the third sidewall 922c, and faces the second sidewall 922b.

The protrusions are formed on the second, third and fourth sidewalls 922b, 922c and 922d, and may be integrally formed with the second, third and fourth sidewalls 922b, 922c and 922d. Alternatively, the protrusions may not be integrally formed with the second, third and fourth sidewalls 922b, 922c and 922d and may be separately formed. The protrusions may include an elastic material such as rubber.

The protrusions are formed on portions of the receiving container 920, which may make contact with side parts of the light guiding plate 910. Thus, the protrusions are not formed on the first sidewall 922a of the receiving container 920, which may not make contact with side parts of the light guiding plate 910.

In one exemplary embodiment, the protrusions includes first, second, third, fourth, fifth, sixth, seventh, eighth and ninth protrusions 923a, 923b, 923c, 923d, 923e, 923f, 923g, 923h and 923i, respectively. Alternatively, the number of the protrusions may be increased or decreased in accordance with a size of the light guiding plate 910 and first, second, third and fourth sidewalls 922a, 922b, 922c and 922d.

The first, second and third protrusions 923a, 923b and 923c protrude from the second sidewall 922b, and are spaced apart from each other. The fourth, fifth and sixth protrusions 923d, 923e and 923f protrude from the third sidewall 922c, and are spaced apart from each other. The seventh, eighth and ninth protrusions 923g, 923h and 923i protrude from the fourth sidewall 922d, and are spaced apart from each other.

When the light guiding plate 910 received in the receiving container 920 drifts due to an external impact, the first, second, third, fourth, fifth, sixth, seventh, eighth and ninth protrusions 923a, 923b, 923c, 923d, 923e, 923f, 923g, 923h and 923i provide a decreased contact area between the first, second and third side faces 914, 915 and 916 of the light guiding plate 910 and the receiving container 920. Thus, a noise induced by friction between the light guiding plate 910 and the receiving container 920 may be prevented.

In one exemplary embodiment, the first, second, third, fourth, fifth, sixth, seventh, eighth and ninth protrusions 923a, 923b, 923c, 923d, 923e, 923f, 923g, 923h and 923i have substantially the same structure. Thus, hereinafter, the first protrusion 923a will be described in detail, and any further descriptions of the second, third, fourth, fifth, sixth, seventh, eighth and ninth protrusions 923b, 923c, 923d, 923e, 923f, 923g, 923h and 923i will be omitted.

Referring to FIG. 12, the first protrusion 923a is positioned on the second sidewall 922b, and has a triangular pyramid shape. Alternatively, the first protrusion 923a may have various polygonal pyramid shapes, for example, such as a quadrangular pyramid shape, a pentagonal pyramid shape, etc.

A surface of the first protrusion 923a extends substantially parallel with the bottom plate 921 of the receiving container 920. When the light guiding plate 910 drifts in the receiving container 920, the first protrusion 923a makes contact with the light guiding plate 910 at a pyramid apex PA only.

Referring again to FIGS. 10 and 11, the receiving container 920 may include first and second bosses 924a and 924b corresponding to first and second holes 311 and 321, respectively, of the optical sheet 300. The first and second bosses 924a and 924b are inserted through the first and second holes 311 and 321, respectively, to fix the optical sheet 300 to the receiving container 920.

Referring to FIG. 10, the receiving container 920 may further include a guide part 925. The guide part 925 guides a liquid crystal display panel (not shown) that displays an image. The guide part 925 is disposed on an upper portion of each of the first, second, third and fourth sidewalls 922a, 922b, 922c and 922d, and extends outwardly in comparison with the first, second, third and fourth sidewalls 922a, 922b, 922c and 922d.

The backlight assembly 900 may further include a back cover 600 disposed outside the receiving container 920. The back cover 600 is disposed adjacent to the lamp unit 100 to rapidly dissipate heat generated from the lamp unit 100. The back cover 600 covers a lower surface of the lamp cover 120 and the first sidewall 922a of the receiving container 920.

In one exemplary embodiment, the backlight assembly 900 includes both the back cover 600 and the lamp cover 120. Alternatively, instead of separately including the back cover 600, the backlight assembly 900 may include a lamp cover having a function of the back cover 600.

Hereinafter, a relationship of the position between the protrusions and the light guiding plate 910 will be described in detail with reference to the accompanying drawings.

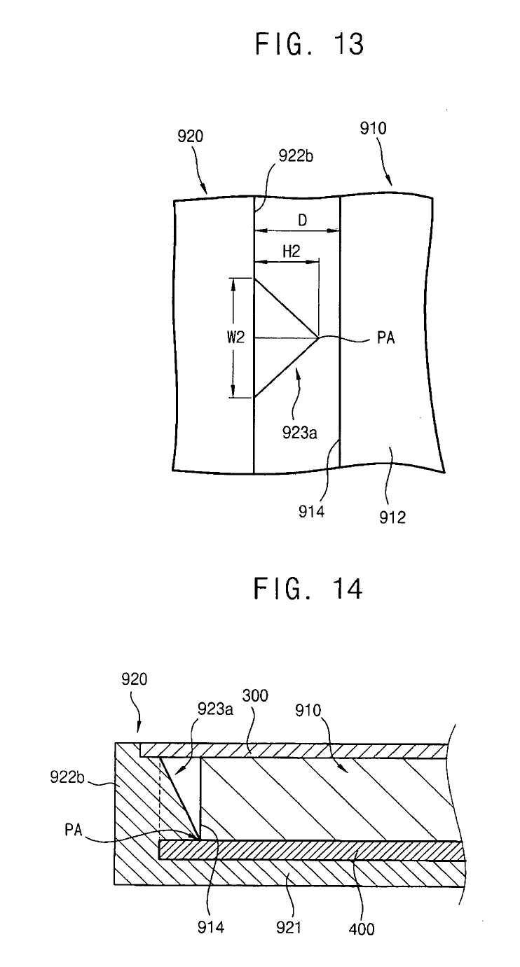

FIG. 13 is a partial plan view illustrating a relationship of the position between the light guiding plate 910 and the receiving container shown 920 in FIG. 10. FIG. 14 is a cross-sectional view taken along a line III-III′ in FIG. 10.

In one exemplary embodiment, the first, second, third, fourth, fifth, sixth, seventh, eighth and ninth protrusions 923a, 923b, 923c, 923d, 923e, 923f, 923g, 923h and 923i have substantially the same positional relationship with respect to the light guiding plate 910. Thus, in FIGS. 13 and 14, a relationship of the position between the first protrusion 923a and the light guiding plate 910 will be described in detail.

Referring to FIGS. 13 and 14, the reflective sheet 400, the light guiding plate 910 and the optical sheet 300 are successively received in the receiving container 920.

The first protrusion 923a formed on the second sidewall 922b of the receiving container 920 is positioned between the second sidewall 922b and the first side face 914 of the light guiding plate 910. A second height ‘H2’ of the first protrusion 923a is smaller than or equal to a distance ‘D’ between the second sidewall 922b of the receiving container 920 and the first side face 914 of the light guiding plate 910. For example, the first protrusion 923a has a second width ‘W2’ of about 0.8 mm and the second height ‘H2’ of about 0.4 mm.

The pyramid apex PA of the first protrusion 923a is adjacent to the first side face 914 of the light guiding plate 910.

When the light guiding plate 910 drifts in the receiving container 920, the first protrusion 923a of the receiving container 920 makes contact with the first side face 914 of the light guiding plate 910. However, the second sidewall 922b of the receiving container 920 does not make contact with the first side face 914 of the light guiding plate 910.

The first protrusion 923a makes contact with the first side face 914 of the light guiding plate 910 at the pyramid apex PA only. In other words, the receiving container 920 makes point contact with the first side face 914 of the light guiding plate 910.

Although not shown in FIGS. 13 and 14, when the light guiding plate 910 drifts in the receiving container 920, the second, third, fourth, fifth, sixth, seventh, eighth and ninth protrusions 923b, 923c, 923d, 923e, 923f, 923g, 923h and 923i shown in FIG. 11 make point contact with the light guiding plate 910 at each pyramid apex only, which is similar to the first protrusion 923a.

As described above, when the light guiding plate 910 drifts in the receiving container 920, the first, second, third, fourth, fifth, sixth, seventh, eighth and ninth protrusions 923a, 923b, 923c, 923d, 923e, 923f, 923g, 923h and 923i of the first, second, third and fourth sidewalls 922a, 922b, 922c and 922d of the receiving container 920 shown in FIG. 11 make contact with the side parts of the light guiding plate 910 at each pyramid apex of a respective protrusion only.

An externally provided force causes the backlight assembly 900 to generate friction between the light guiding plate 910 and the receiving container 920, thereby generating a noise. The pyramid apexes of the first, second, third, fourth, fifth, sixth, seventh, eighth and ninth protrusions 923a, 923b, 923c, 923d, 923e, 923f, 923g, 923h and 923i of the receiving container 920 make contact with the first, second and third side faces 914, 915 and 916 of the light guiding plate 910 shown in FIG. 10, so that a contact area between the receiving container 920 and the light guiding plate 910 is reduced.

Thus, the noise induced by the friction between the light guiding plate 910 and the receiving container 920 may be prevented.

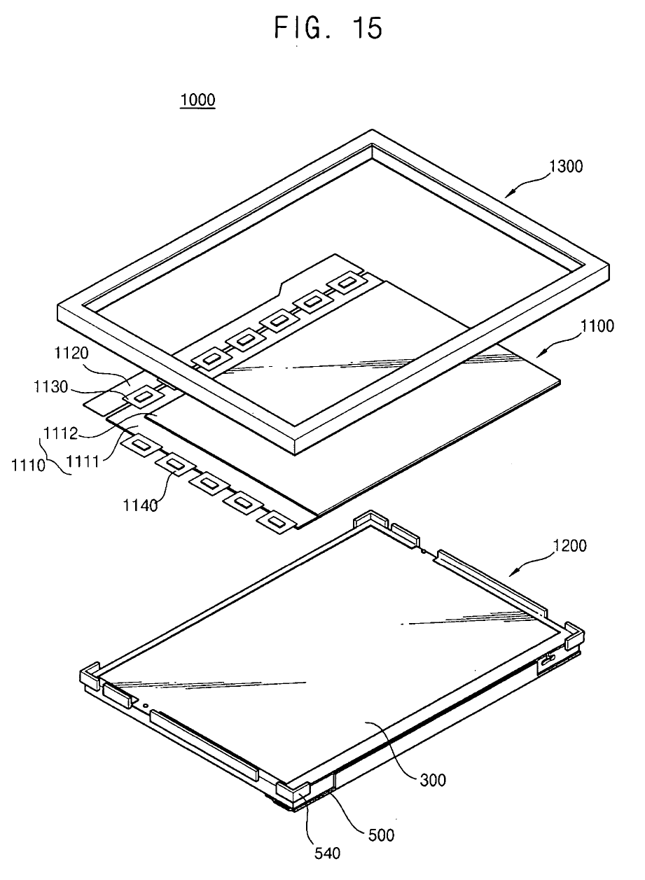

FIG. 15 is an exploded perspective view illustrating a liquid crystal display device according to an exemplary embodiment of the present invention.

Referring to FIG. 15, a liquid crystal display (LCD) device 1000 includes a display panel assembly 1100, a backlight assembly 1200 and a top chassis 1300. The display panel assembly 1100 displays an image using light generated from the backlight assembly 1200. The top chassis 1300 guides a position of the display panel assembly 1100.

The backlight assembly 1200 of the liquid crystal display (“LCD”) device 1000 has substantially the same structure as the backlight assembly 800 shown in FIG. 1. Thus, any further descriptions of substantially the same elements will be omitted.

The display panel assembly 1100 includes an LCD panel 1110 displaying an image corresponding to an image signal by using the light, a printed circuit board (“PCB”) 1120 generating a driving signal corresponding to the image signal, a data tape carrier package “TCP”) 1130 and a gate TCP 1140.

Particularly, the LCD panel 1110 includes a thin film transistor (“TFT”) substrate 1111, a color filter substrate 1112 facing the TFT substrate 1111 and a liquid crystal layer (not shown) disposed between the TFT substrate 1111 and the color filter substrate 1112.

A plurality of pixels (not shown) are formed on the TFT substrate 1111 and are arranged in a matrix shape. Each of the pixels is defined by a gate line (not shown) and a data line (not shown). The gate line and data line are substantially perpendicular to each other. A TFT as a switching element and a pixel electrode are formed on each of the pixels.

The color filter substrate 1112 includes a plurality of red green blue (“RGB”) color pixels (not shown) and a common electrode. The RGB color pixels are formed through a thin film process, and generate a predetermined color using the light.

The liquid crystal layer is disposed between the TFT substrate 1111 and the color filter substrate 1112. Electric fields generated between the pixel electrode and the common electrode rearrange liquid crystal molecules of the liquid crystal layer to control transmissivity of the light provided from the backlight assembly 1200.

The PCB 1120 is disposed at a source side of the LCD panel 1110. The PCB 1120 includes a driver chip, a timing controller and a memory. The driver chip generates the driving signal. The timing controller controls a timing of the driving signal. The memory stores a data signal and a gate signal.

The data TCP 1130 is disposed at an end portion of the PCB 1120. The data TCP 1130 is electrically connected to the LCD panel 1110 and the PCB 1120 to provide the driving signal and the data signal from the PCB 1120 to the LCD panel 1110.

The gate TCP 1140 is attached to a gate side of the LCD panel 1110. The gate TCP 1140 applies the gate signal and the driving signal, which is provided from the PCB 1120, to the LCD panel 1110.

The backlight assembly 1200 is disposed under the display panel assembly 1100 and provides uniform light to the LCD panel 1110.

The LCD panel 1110 is received in the receiving container 500 of the backlight assembly 1200. A guide part 540 of the receiving container 500 guides and facilitates positioning of the LCD panel 1110 with the receiving container 500.

The top chassis 1300 is disposed over the LCD panel 1110 and fixes the LCD panel 1110 to the receiving container 500. The top chassis 1300 faces the receiving container 500 of the backlight assembly 1200 and is combined with the receiving container 500 of the backlight assembly 1200, so that the LCD panel 1110 is fixed to the receiving container 500.

According to exemplary embodiments of the present invention, a backlight assembly includes a receiving container, and a light guiding plate having a plurality of protrusions that protrude from a side face and is adjacent to a sidewall of the receiving container. When the light guiding plate drifts in the receiving container, the protrusions of the light guiding plate make contact with the sidewall of the receiving container, but the side face of the light guiding plate does not make contact with the sidewall of the receiving container.

Thus, even though an externally provided force transforms the backlight assembly, a contact area between the light guiding plate and the sidewall of the receiving container is reduced. Hence, a noise induced by friction between the receiving container and the light guiding plate is prevented and a manufacturing yield of both the light guiding plate and receiving container is thereby enhanced.

In other exemplary embodiments of the present invention, a backlight assembly includes a light guiding plate, and a receiving container having a plurality of protrusions that are adjacent to a side face of the light guiding plate. When the light guiding plate drifts in the receiving container, the protrusions of the receiving container make contact with the side face of the light guiding plate, but the sidewall of the receiving container does not make contact with the side face of the light guiding plate.

Thus, even though an externally provided force transforms the backlight assembly, a contact area between the receiving container and the side face of the light guiding plate is reduced. Hence, a noise induced by friction between the receiving container and the light guiding plate is prevented, a manufacturing yield thereof is enhanced.

Although the exemplary embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. A backlight assembly comprising:
a receiving container; and
a light guiding plate comprising:
a base plate; and
a protrusion formed on a surface of the base plate, the protrusion making point contact with the receiving container.

2. The backlight assembly of claim 1, wherein the protrusion is formed on a side face of the base plate.

3. The backlight assembly of claim 1, wherein the protrusion has a pyramid shape.

4. The backlight assembly of claim 3, wherein the protrusion of the light guiding plate makes contact with a sidewall of the receiving container at only an apex of the protrusion, at least three surfaces of the protrusion defining the apex.

5. The backlight assembly of claim 1, wherein the protrusion is integrally formed with the base plate.

6. The backlight assembly of claim 1, wherein the protrusion comprises an elastic material.

7. The backlight assembly of claim 1, wherein the protrusion has a smaller coefficient of friction than the base plate.

8. The backlight assembly of claim 1, wherein the light guiding plate further comprises a noise-proof member that covers an outer surface of the protrusion, the noise-proof member having a smaller coefficient of friction than the receiving container and the protrusion.

9. A backlight assembly comprising:
a receiving container; and
a light guiding plate comprising:
a base plate; and
a protrusion formed on a surface of the base plate, the protrusion making line contact with the receiving container.

10. The backlight assembly of claim 9, wherein the protrusion is formed on a side face of the base plate.

11. The backlight assembly of claim 9, wherein the protrusion has a prism shape.

12. The backlight assembly of claim 9, wherein the protrusion comprises, a curved surface.

13. The backlight assembly of claim 9, wherein the protrusion is integrally formed with the base plate.

14. The backlight assembly of claim 9, wherein the protrusion comprises an elastic material.

15. The backlight assembly of claim 9, wherein the protrusion has a smaller coefficient of friction than the base plate.

16. The backlight assembly of claim 9, wherein the light guiding plate further comprises a noise-proof member that covers an outer surface of the protrusion, the noise-proof member having a smaller coefficient of friction than the receiving container and the light guiding plate.

17. A backlight assembly comprising:
a light guiding plate configured to change an optical path of light and emit the light;
a light source disposed at a side of the light guiding plate to generate the light; and
a receiving container comprising:
a bottom plate on which the light guiding plate and the light source are disposed;
a sidewall extended from the bottom plate to face a side portion of the light guiding plate; and
a protrusion protruding from the sidewall to space the sidewall apart from the side portion of the light guiding plate.

18. The backlight assembly of claim 17, wherein the protrusion makes point contact with the side portion of the light guiding plate.

19. The backlight assembly of claim 17, wherein the protrusion makes line contact with the side portion of the light guiding plate.

20. A display device comprising:
a receiving container;
a light guiding plate comprising:
a base plate received in the receiving container to change an optical path of light; and
a protrusion disposed on a surface of the base plate, the protrusion making point contact with the receiving container;
a light source disposed at a side of the light guiding plate to provide the light to the light guiding plate; and
a display panel disposed over the light guiding plate to display an image using the light from the light guiding plate.

21. A display device comprising:
a receiving container;
a light guiding plate comprising:
a base plate received in the receiving container to change an optical path of light; and
a protrusion disposed on a surface of the base plate, the protrusion making line contact with the receiving container;
a light source disposed at a side of the light guiding plate to provide the light to the light guiding plate; and
a display panel disposed over the light guiding plate to display an image using the light from the light guiding plate.

22. A display device comprising:
a display panel configured to display an image using light;
a light guiding plate configured to change an optical path of the light and provide the light to the display panel;
a light source disposed at a side of the light guiding plate to generate the light; and
a receiving container comprising:
a bottom plate on which the light guiding plate and the light source are disposed;
a sidewall extending from the bottom plate to face a side portion of the light guiding plate; and
a protrusion protruding from the sidewall to space the sidewall apart from the side portion of the light guiding plate.
